(19) United States
(12) Patent Application Publication
(10) Pub. No.: US 2006/0101397 A1
(43) Pub. Date: May 11, 2006

(54) Pseudo-random test case generator for XML APIs

(75) Inventors: Ian Cameron Mercer, Sammamish, WA (US); Michael Ying-Kee Tsang, Kirkland, WA (US)

Correspondence Address: SENNIGER POWERS, ONE METROPOLITAN SQUARE, 16TH FLOOR, ST. LOUIS, MO, 63102, US

(73) Assignee: Microsoft Corporation, Redmond, WA (US)

(21) Appl. No.: 10/976,400

(22) Filed: Oct. 29, 2004

(51) Int. Cl. G06F 9/44

(52) U.S. Cl. 717/120; 717/123; 717/124

(57) ABSTRACT

A test case generator including a test model generator for generating test models. A test case instance generator uses a permutation engine to generate test matrices from the tests models and generates XML documents from the test matrices. The documents are applied to an XML-based application interface to test the interface.

### TECHNICAL FIELD

Embodiments of the present invention relate to the field of testing XML-based application interfaces comprising a set of routines used by an application program to direct performance of procedures by a computer's operating system (e.g., used as an application programming interface or API). In particular, embodiments of this invention relate to a pseudo-random test case generator and method for creating XML documents for testing XML-based application program interfaces with predictive repeatability.

### BACKGROUND OF THE INVENTION

With the advent of XML (eXtensible Markup Language) and its capability in describing applications and their corresponding data, metadata, and behavior, XML has become an important technology in many software applications today. Many vertical software industry segments even create variations of XML that specifically suit the needs of their domains. At its basic form, XML can be used by any application to describe its metadata and how data should be handled and processed, through an XSD (XML Schema Definition) schema.

One of the many forms in which XML is used is as an application interface. Traditional application programming interfaces (API) take the form of a function call (for procedural programming languages) or an object method (for object-oriented programming languages). As APIs become more complex and difficult to manage, XML offers an alternative where many pieces of disparate yet related information can be centralized in a single XML document and passed to the target application. These XML documents can be actual files on a hard disk, or be serialized into binary data streams, or some other forms of data consumable by the target application.

In testing these XML-based application interfaces, a significant challenge arises in which there is unlimited ways to define an XSD schema for an application through which there are unlimited ways to define an XML document that exposed by the application under test conforms to functional and feature specifications as set out in the application design. This is very different from conventional API testing where each API has only several well-defined and usually strongly typed parameters. Existing software testing methodologies like model-based testing can be insufficient in addressing this problem due to difficulties in establishing a comprehensive yet valid finite state model for such a loosely defined behavioral space.

Although XML instance document generation is possible, existing tools are usually general purpose generators and thus lack some of the important features that software testing requires, such as sufficient coverage, randomness, a reasonable number of instances and a controlled series with predicted repeatability.

### SUMMARY OF THE INVENTION

Thus, there is a need for generating a series of instances, which provide sufficient coverage for all elements, attributes, types, and any other forms of metadata defined in the schema. There is also a need for the same series of generated instances to exhibit true randomness. It is also preferable that the number of instances in the series not be prohibitively large in order to provide sufficient coverage because in many cases exhaustive testing of all instances is simply impossible. There is also a need for instances to be generated in a controlled series in such a way that various parameters can be optionally specified according to the needs of testing at the time, e.g., such parameters may include: number of instances to generate, combinatorial complexity of the generated series, maximum number of recursive levels to generate, optional elements and/or attributes not to generate, statistical likelihood of generating any particular element and/or attribute, specific values to use for any particular element and/or attribute, and specific pattern or constraints annotations to be used for each individual element. There is also a need for a randomly generated series of instances to be able to be regenerated in its entirety and in the same order. This is important for defect reproduction in the event a particular instance causes a defect in the application interface to be exposed.

Accordingly, a pseudo-random test case generator and method for XML-based application program interfaces with predictive repeatability according to the invention is desired to address one or more of these and other needs.

The invention includes an XML generator for automated testing of any XML-based application interfaces in accordance with a pre-defined XSD schema. In one embodiment, the components of the XML instance generator include: 1) a test model generator which parses the XSD schema and generates a separate model for each metadata within it, 2) a customizable permutation engine which performs combinatorial permutations of variables, and 3) an XML instance generator which uses the permutation engine to build combinatorial test matrices as a function of the generated test models.

Embodiments of the invention include a system and method for automated testing of an XML-based application interface by a test case generator for verifying and validating functional and feature requirements of such an interface. The XSD schema defines what kind of XML document can be allowed through the interface. This invention relates to testing the XML interface.

A strategic importance of this invention lies in its general applicability to any software application interface or inter-process communication that uses XML as a means of communication. In addition, this invention can help improve software testing efficiency of other products as well as external software development partners, which will minimize potential revenue loss due to time-to-market issues.

In one form, the invention comprises a CRM having stored thereon instructions for testing an XML-based application interface as defined by an XSD schema and for determining whether the XML-based application interface exposed by an application under test conforms to functional and feature specifications of a design corresponding to the application. The instructions comprise model generator instructions for parsing the XSD schema to selectively identify metadata defined in the XSD schema for generating test models corresponding to the identified metadata; and test case generator instructions for generating test matrices corresponding to the test models.

In another form, the invention comprises a method of testing an XML-based application interface as defined by an XSD schema, with respect to an application exposing such an interface, said method comprising: parsing the XSD schema to selectively identify metadata defined in the XSD schema; generating test models corresponding to the identified metadata; generating test matrices corresponding to the test models; and generating XML documents using the test matrices.

In another form, the invention comprises a CRM having stored thereon an XML test generator for an XML application interface. A test model generator parses an XSD schema defining the XML interface and generates a separate test model for each element within it. A customizable permutation engine performs combinatorial permutations of variables within the generated test models. An XML instance generator uses the permutation engine to build combinatorial test matrices as a function of the generated test models.

In another form, the invention comprises a system comprises a memory area storing model generator instructions for parsing an XSD schema to selectively identify metadata defined in the XSD schema for generating test models corresponding to the identified metadata; and storing test case generator instructions for generating test matrices corresponding to the test models; and a processor for executing the stored model generator instructions and the stored test generator instructions.

In another form, the invention is a system. A processor executes an application exposing an XML-based application interface defined by an XSD schema. Means generates test models for metadata defined by the XSD schema. Means generates test matrices from the test models, the test matrices including permutations of the metadata. Means generates XML test documents from the test matrices. The test documents are applied to the XML application interface to determine whether the XML application interface exposed by the application under test conforms to functional and feature specifications of a design corresponding to the application.

Alternatively, the invention may comprise various other methods and apparatuses.

Other features will be in part apparent and in part pointed out hereinafter.

### BRIEF DESCRIPTION OF THE DRAWINGS AND APPENDICES

FIG. 1 is an exemplary embodiment of a block diagram illustrating the test case generator and related elements of one embodiment of the invention.

FIG. 2 is an exemplary block diagram illustrating the test model generator's internal logic flow for each unique metadata item in the XSD schema, according to one embodiment of the invention.

FIG. 3 is an exemplary flow chart illustrating the test case generator internal flow logic according to one embodiment of the invention.

FIG. 4 is a diagram illustrating an exemplary set of test matrices according to one embodiment of the invention.

FIG. 5 is a block diagram illustrating one example of a suitable computing system environment in which the invention may be implemented.

Appendix 1 is an exemplary XSD schema to which an XML-based application interface must conform; the exemplary XSD schema would be used by a generator or method of the invention to test the XML-based application.

Appendix 2 is an exemplary test model generated by a generator or method of the invention.

Appendix 3 is an exemplary values file generated by a generator or method of the invention (which file may be modified by a user) to specify values for specific metadata items during model generation.

Appendix 4 is an exemplary test matrix generated by a generator or method of the invention.

Appendix 5 is an exemplary constraints file generated by a generator or method of the invention (which file may be modified by a user) to specify constraining conditions for the permutations engine to follow when it executes combinatorial permutations.

Appendix 6 is an exemplary annotation file generated by a generator or method of the invention (which file may be modified by a user) to specify generation patterns during instance generation.

Corresponding reference characters indicate corresponding parts throughout the drawings.

### DETAILED DESCRIPTION OF THE INVENTION

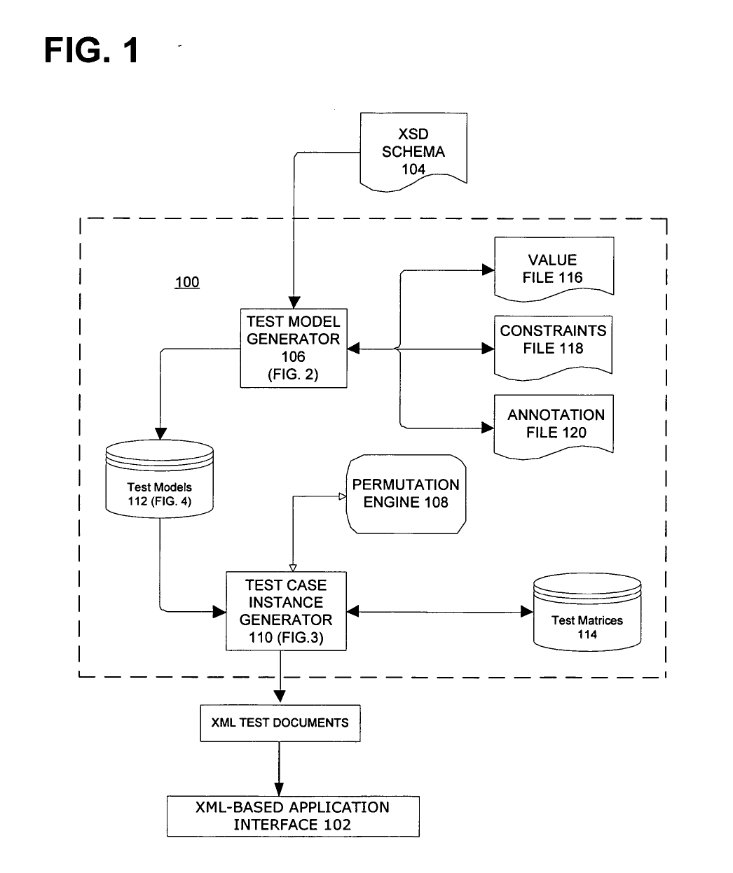

Referring first to FIG. 1, an embodiment of an XML generator 100 according to the invention is illustrated. XML generator 100 supports the above features and, in one embodiment, comprises instructions on a computer readable medium. The generator 100 is used to generate test cases for XML-based application interfaces 102 with respect to a pre-defined XSD schema 104 to verify and validate functional and feature requirements of such interfaces 102. By way of example only, Appendix 1 is an exemplary embodiment of an XSD schema.

In one embodiment, the XML generator 100 includes a test model generator 106, a permutation engine 108 (e.g., pair wise generation engine which looks at and randomizes parameter pairs) and an XML test case instance generator 110. The test model generator 106 generates a separate model 112 for each metadata element, (attribute, type or other item) in the XSD schema 104 and optionally describes the possible content or value of the metadata (hereinafter referred to as elements) in a value file 116. By way of example only, Appendix 2 is an exemplary embodiment of a test model 112. By way of example only, Appendix 3 is an exemplary embodiment of a value file 116. It may also optionally accept user specified values for specific elements or other items in the schema. The permutation engine 108 performs combinatorial permutation of variables in the value file 116. Optionally, it may be customizable in terms of the combinatorial complexity during the permutation process. Many permutation algorithms and tools are available in the public domain which one can choose to use instead of creating their own. The XML test case instance generator 110 uses the permutation engine 108 to build a plurality of combinatorial test matrices 114 (e.g., XML documents) based on the test models 112 generated by the test model generator 106. By way of example only, Appendix 4 is an exemplary embodiment of a test matrix 114. The test matrices 114 will then be subsequently used to generate XML instance documents applied to the interface 102.

There are several optional features which the permutation engine may have: random generation may be based on a master seed and subsequent random numbers within the same series may be generated based on this seed; instance generator may accept user-specified master seed so that any series of random numbers can be reproduced; number of instances to generate may be customizable; generation may be able to terminate if the XSD schema is defined in such a way that it is possible to create instance documents of infinite depth; and patterns and values to be generated may be customizable through user annotations.

Generator 106 may generate the value file 116, noted above, which may be modified by a user to specify values to use for specific elements and attributes during test model generation. Optionally, generator 106 may generate a constraints file 118 which may be modified by a user to specify constraining conditions for the permutation engine to follow during combinatorial permutation. By way of example only, Appendix 5 is an exemplary embodiment of a constraints file 118. Optionally, generator 106 may generate an annotation file 120 which may be modified by a user to specify generation patterns during instance generation. By way of example only, Appendix 6 is an exemplary embodiment of an annotation file 120.

Test model generator 106 optionally parses the value file 116 and the constraints file 118 and generates one model for each element in the XSD schema. These models will incorporate any user-specified values in the value file 116 and constraints in constraints file 118. The XML instance generator 110 parses the test models 112, feeds the parsed models to the permutation engine 108, receives test matrices 114 generated using the permutation engine 108 as constrained by the constraints file 118.

Instance generator 110 begins to generate XML instance documents to test the interface 102 by using permutation engine 108 to generate a value for the root element, which is the same for each instance. Each instance document is then generated by randomly selecting a value for each element's children from the test matrix 114 of that element, in a recursive fashion. Generation of each element is constrained by the conditions specified in the constraints file 118. Generation of an instance document is terminated either when no more elements have children or when the XML depth limit is reached, which limit may be user specified or modified.

One embodiment of the test model generator 106 has two (2) stages of operation comprising instructions on a computer readable medium. A first stage simply parses the given XSD schema and discovers all elements (i.e., metadata) defined in the schema, and output template files for user input of primitive values, constraining relationships. Operations in this first stage are straightforward and may be performed manually by a human who understands XSD. It involves producing empty templates.

One embodiment for implementing user input of primitive values into value file 116 and constraining relationships in constraints file 118 is to output template files which may be completed by a user. Alternatively, other methods like graphical user interface or command line parameters can also be used. Those skilled in the art will recognize other alternatives.

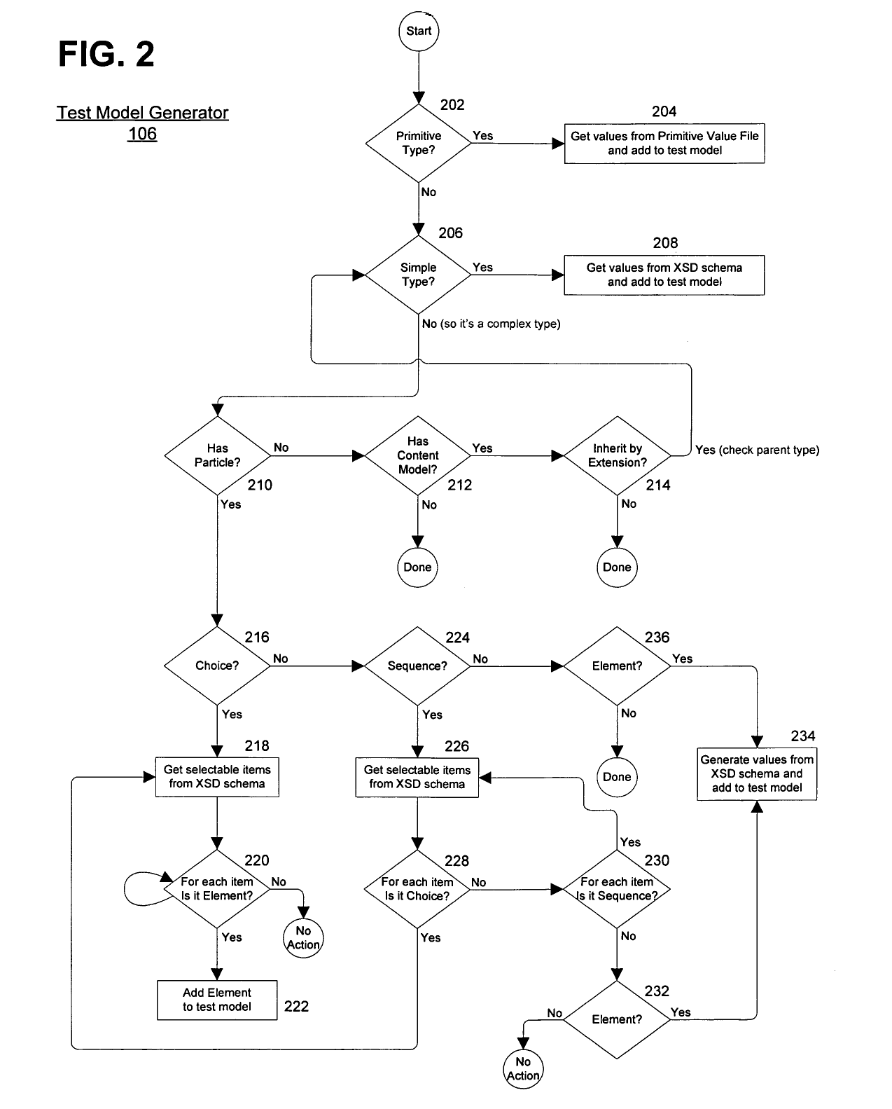

Referring next to FIG. 2, the second stage of the test model generator 106 involves generating a test model for each defined metadata in the XSD schema. The format of the models depends on the requirements of the permutation engine 108.

In general, one embodiment of the parsing and generation process of each element involves the following as illustrated in FIG. 2:

1. At 202, if element is of primitive type, then get specific test values from user at 204. E.g. from a template file completed by the user.

2. At 206, if element is of simple type (no nested types), then get values from the schema at 208.

3. At this point, the element must be of complex type. It must then be recursively parsed to obtain all elements including those of any inherited parent types. Several guidelines apply as follows:

a. At 210, if the type does not contain an XML Schema Particle then recurs into the particle, check for an XML Schema Content Model at 212. If there is a content model then check for inheritance by extension at 214, and if yes, parse its parent type by returning to 206.

b. At 216, if an XML Schema Particle contains an XML Schema Choice, then parse all selectable items within the choice at 218.

c. At 220, for each item in an XML Schema Choice, if it is an XML Schema Element, then add it to the test model at 222.

d. At 224, if an XML Schema Particle contains an XML Schema Sequence, then parse all selectable items within the sequence at 226.

e. At 228, if an XML Schema Sequence contains an XML Schema Choice then recurs at 218.

f. At 230, if an XML Schema Sequence contains an XML Schema Sequence then recurs at 226.

g. At 232, if an XML Schema Sequence contains an XML Schema Element then generate values from the XSD schema at 234 based on defined lower and upper bounds, and add them to the test model.

h. At 236, if an XML Schema Particle contains an XML Schema Element, then generate values from the XSD schema at 234 based on defined lower and upper bounds, and add them to the test model.

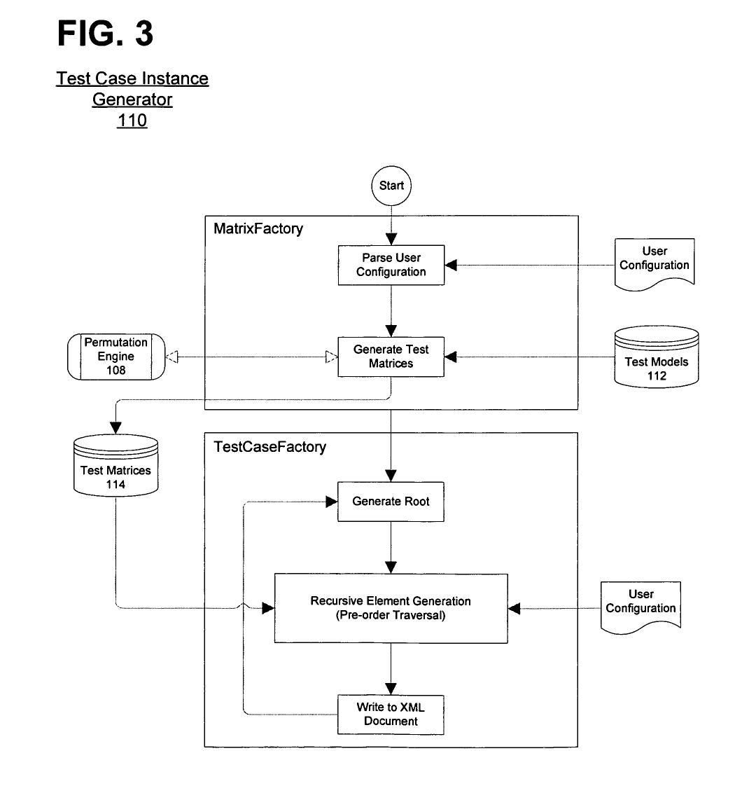

Referring next to FIG. 3, one embodiment of test case (XML instance) generator 110 has two (2) stages comprising instructions on a computer readable medium. A first stage, labeled MatrixFactory because it generates test matrices 114, involves the optional parsing of any user configuration [e.g. maximum number of cases to generate, combinatorial complexity of the generated series, etc.] as specified in the user configuration file. User configuration information may be specified through various ways, e.g., a configuration file, a graphical user interface, command line parameters, etc. Those skilled in the art will recognize other alternatives. The first stage uses the permutation engine 108 to generate the combinatorial test matrices 114 for each test model 112 created by the test model generator 106. The test matrices 114 are then saved for later use.

In a second stage, labeled TestCaseFactory because it generates tests cases, the test case generator 110 repeatedly goes through a recursive process of generating elements, attributes, and values (i.e., metadata) starting with the XML root element (which is the same for every test case). For each metadata element it encounters, it randomly extracts an entry from the test matrix 114 that corresponds to that element. The generation pattern is controlled by the annotation file 120. This process may use a standard pre-order traversal algorithm, i.e. for every element it first generates the element itself then followed by generation of any children of the element. During the generation process, any user configuration data is optionally taken into account to control various aspects of the outcome, e.g. maximum number of test case, maximum depth of the test case (XML document), etc. When the generation of a single test case is complete, it is written out in the form of an XML document. The test case generator 110 then proceeds to generate the next test case until it reaches the maximum number of test cases.

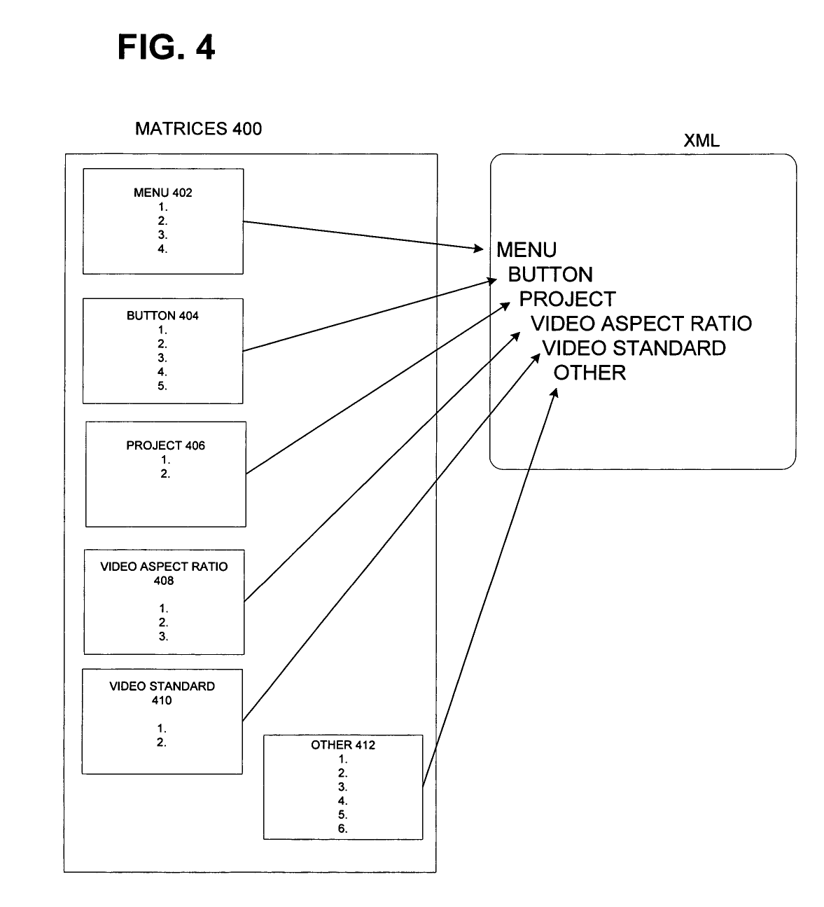

Referring next to FIG. 4, an exemplary set of test matrices 400 are illustrated. In this example, it is assumed that the tester wants to generate matrices of test values to test menu, button, project, video aspect ratio, video standard and/or other functions of an XML-based application interface 102. The patterns that will be generated could be specified as text in the annotation file 120. In other matrices, text may not be needed and, for example, a specific series or pattern of characters may be needed to test a particular bug. For example, the button text may be a repetitive pattern of some special characters and the repetitive pattern can be considered by the application interface 102 as the identification of a certain error condition. The illustrated matrices 400 are essentially a database or source of values, including a list of menu items 402, button items 404, project items 406, video aspect ratios 408, video standards 410 and/or other items 412, each having different instances which are selected and used to generate XML documents to test the interface 102. For example, menu 402 has 4 instances, button 404 has 5 instances, project 406 has 2 instances and so on. The instances are randomly selected to create various XML documents which are then applied to the interface 102 to test it. The particular values within the test matrices 114 are generated by the permutation engine 108. In summary, the test models 112 are generated by the test model generator 106. Then, the test matrices 114 are generated by the test case instance generator 110 using the permutation engine 108 as a function of the test models 112. Then, the XML documents are generated by the generator 110 using the matrices 114. Thus, the interface is tested by the generated XML documents.

According to one embodiment of the invention, the efficiency and coverage of testing of XML-based application interfaces 102 is increased by providing the following advantages: automated test case generation prevents manual test case development mistakes; no more “hit and miss” test cases; amount of engineering hours devoted to test case development is dramatically reduced; testers can spend more time creating specific test scenarios not covered by instance generation; random generation ensures statistically significant coverage of the entire XSD schema; combinatorial pairing of test values provides even distribution, thus exercising all components of the schema;

Desired test coverage can be obtained without exhaustively testing all combinations of schema elements, attributes, and other metadata; number of test case generated can be tuned by adjusting the combinatorial complexity; amount of time required for actual test runs is dramatically reduced, thus resulting in faster turnaround and quicker deliverables, which ultimately increases a product's time-to-market efficiency; controlled generation allows customized test runs based on actual testing needs at the time of the test runs; generated instances can contain user-specified values, giving more flexibility in representing real world scenarios expected by the application interface; patterns and constraints for each individual element can be specified; and any generated series of random instances can be regenerated as needed for the purpose of defect reproduction.

When utilized together with other testing framework components, the invention as a result provides effective software testing not only in XML-based application interface but also other types of software, e.g. XML Web Services. With a complete end-to-end testing framework including the invention, one can automate the process of XML software testing from test case generation and test execution to test validation and test result analysis.

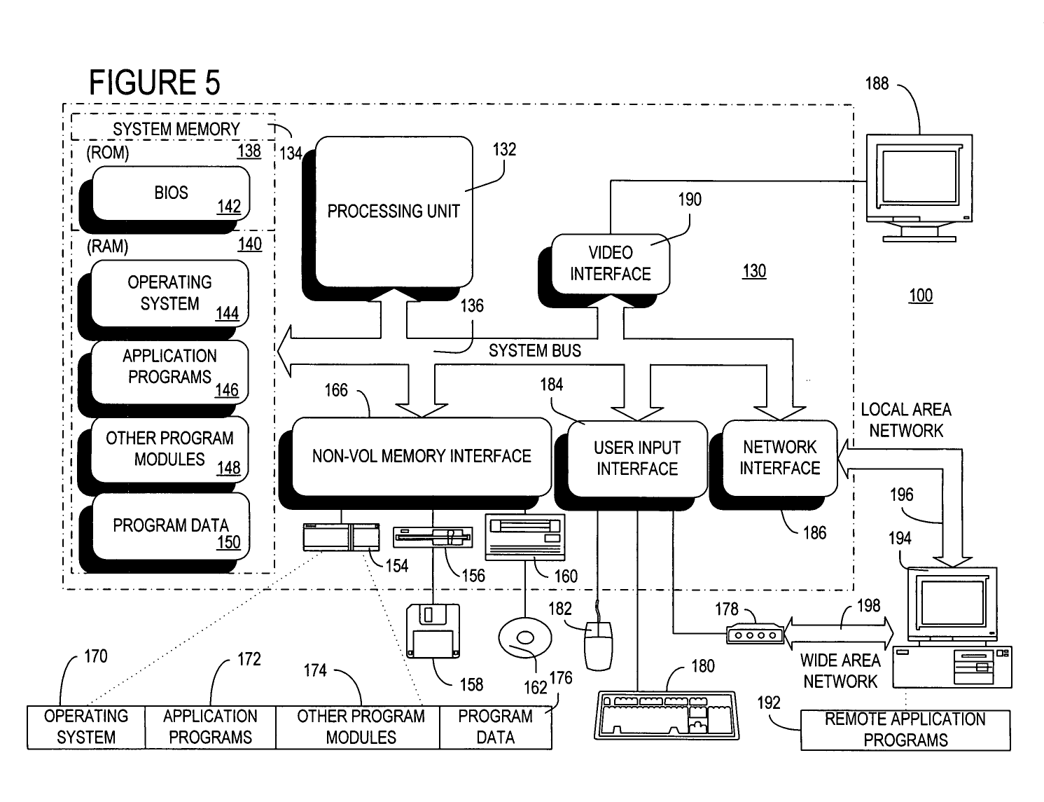

FIG. 5 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that may be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between elements within computer 130, such as during start-up, is typically stored in ROM 138. RAM 140 typically contains data and/or program modules that are immediately accessible to and/or presently being operated on by processing unit 132. By way of example, and not limitation, FIG. 5 illustrates operating system 144, application programs 146, other program modules 148, and program data 150.

The computer 130 may also include other removable/non-removable, volatile/nonvolatile computer storage media. For example, FIG. 5 illustrates a hard disk drive 154 that reads from or writes to non-removable, nonvolatile magnetic media. FIG. 5 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 5, provide storage of computer readable instructions, data structures, program modules and other data for the computer 130. In FIG. 5, for example, hard disk drive 154 is illustrated as storing operating system 170, application programs 172, other program modules 174, and program data 176. Note that these components may either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 5 include a local area network (LAN) 196 and a wide area network (WAN) 198, but may also include other networks. LAN 136 and/or WAN 138 may be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 5 illustrates remote application programs 192 as residing on the memory device. The network connections shown are exemplary and other means of establishing a communications link between the computers may be used.

Either or both of the application programs 146 and the remote application programs 192 may have APIs, which must conform to an XSD schema. According to one embodiment of the invention, the XML interface 102, the XSD schema, the application exposing the XML interface, and instructions for the test case generator 100 (e.g., files 116, 118, 120, models 112, permutation engine 108, test matrices 114, generator 106 and generator 110) would be stored on a computer readable medium such as non-volatile memory accessible via interface 166 or such as RAM 140. The processing unit 132 executes the instructions and provides XML documents to the APIs of the programs to determine whether the APIs conform to functional and feature requirements as set out in the application design.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

An interface in the context of a software architecture includes a software module, component, code portion, or other sequence of computer-executable instructions. The interface includes, for example, a first module accessing a second module to perform computing tasks on behalf of the first module. The first and second modules include, in one example, application programming interfaces (APIs) such as provided by operating systems, component object model (COM) interfaces (e.g., for peer-to-peer application communication), and extensible markup language metadata interchange format (XMI) interfaces (e.g., for communication between web services).

The interface may be a tightly coupled, synchronous implementation such as in Java 2 Platform Enterprise Edition (J2EE), COM, or distributed COM (DCOM) examples. Alternatively or in addition, the interface may be a loosely coupled, asynchronous implementation such as in a web service (e.g., using the simple object access protocol). In general, the interface includes any combination of the following characteristics: tightly coupled, loosely coupled, synchronous, and asynchronous. Further, the interface may conform to a standard protocol, a proprietary protocol, or any combination of standard and proprietary protocols.

The interfaces described herein may all be part of a single interface or may be implemented as separate interfaces or any combination therein. The interfaces may execute locally or remotely to provide functionality. Further, the interfaces may include additional or less functionality than illustrated or described herein.

The order of execution or performance of the methods illustrated and described herein is not essential, unless otherwise specified. That is, elements of the methods may be performed in any order, unless otherwise specified, and that the methods may include more or less elements than those disclosed herein. For example, it is contemplated that executing or performing a particular element before, contemporaneously with, or after another element is within the scope of the invention.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions, products, and methods without departing from the scope of the invention, it is intended that all matter contained in the above description and shown in the accompanying drawings shall be interpreted as illustrative and not in a limiting sense.

### Appendix 1

Appendix 1 is an exemplary XSD schema to which an XML-based application interface must conform; the exemplary XSD schema would be used by a generator or method of the invention to test the XML-based application.

Exepmplary XSD Schema 104

<?xml version=“1.0” encoding=“utf-8”?>
<xs:schema xmlns:tns=“http://www.microsoft.com/OpticalMediaDisc/OpticalDiscSchema.xsd”
elementFormDefault=“qualified”
targetNamespace=“http://www.microsoft.com/OpticalMediaDisc/OpticalDiscSchema.xsd”
xmlns:xs=“http://www.w3.org/2001/XMLSchema”>

<xs:element name=“Project” type=“tns:Project” />
<xs:complexType name=“Project”>

<xs:sequence>

<xs:element minOccurs=“0” maxOccurs=“1” name=“ROMSectionRoot” type=“tns:Folder” />
<xs:element minOccurs=“0” maxOccurs=“1” name=“SubpicturePalette” type=“xs:string” />
<xs:choice minOccurs=“0” maxOccurs=“unbounded”>

<xs:element minOccurs=“0” maxOccurs=“1” name=“SlideShow” type=“tns:SlideShow” />
<xs:element minOccurs=“0” maxOccurs=“1” name=“Media” type=“tns:Media” />
<xs:element minOccurs=“0” maxOccurs=“1” name=“Menu” type=“tns:Menu” />

</xs:choice>

</xs:sequence>
<xs:attribute name=“Name” type=“xs:string” />
<xs:attribute name=“FirstPlay” type=“xs:string” />
<xs:attribute name=“JacketPicture” type=“xs:anyURI” />
<xs:attribute name=“Schema Version” type=“xs:string” />
<xs:attribute name=“Language” type=“xs:language” />
<xs:attribute name=“Encoding” type=“xs:string” />
<xs:attribute name=“DiscBurner” type=“xs:string” />
<xs:attribute name=“DiscVolumeOnHardDrive” type=“xs:string” />
<xs:attribute name=“TempFolder” type=“xs:string” />
<xs:attribute name=“DiscType” type=“tns:EnumDiscType” use=“required” />
<xs:attribute name=“VideoSetting” type=“tns:EnumVideoSetting” use=“required” />
<xs:attribute name=“AspectRatio” type=“tns:EnumAspectRatio” />
<xs:attribute name=“NumberOfCopies” type=“xs:int” />
<xs:attribute name=“AutoMenus” type=“xs:boolean” />

</xs:complexType>
<xs:complexType name=“Folder”>

<xs:sequence>

<xs:choice minOccurs=“0” maxOccurs=“unbounded”>

<xs:element minOccurs=“1” maxOccurs=“1” name=“Folder” nillable=“true” type=“tns:Folder” />
<xs:element minOccurs=“1” maxOccurs=“1” name=“File” nillable=“true” type=“xs:anyURI” />

</xs:choice>

</xs:sequence>
<xs:attribute name=“Name” type=“xs:string” />

</xs:complexType>
<xs:complexType name=“SlideShow”>

<xs:complexContent mixed=“false”>

<xs:extension base=“tns:Content”>

<xs:sequence>

<xs:element minOccurs=“0” maxOccurs=“unbounded” name=“Media” nillable=“true”

type=“tns:Media” />

<xs:element minOccurs=“0” maxOccurs=“unbounded” name=“Subtitle” nillable=“true”

type=“tns:Subtitle” />

</xs:sequence>
<xs:attribute name=“PlayDuration” type=“xs:time” use=“required” />
<xs:attribute name=“TransitionDuration” type=“xs:time” use=“required” />
<xs:attribute name=“BackgroundAudio” type=“xs:anyURI” />
<xs:attribute name=“EndAction” type=“xs:IDREF” />

</xs:extension>

</xs:complexContent>

</xs:complexType>
<xs:complexType name=“Content” abstract=“true”>

<xs:complexContent mixed=“false”>

<xs:extension base=“tns:Target”>

<xs:sequence>

<xs:element minOccurs=“0” maxOccurs=“unbounded” name=“ItemParam” type=“tns:ItemParam” />
<xs:element minOccurs=“0” maxOccurs=“1” name=“SubpicturePalette” type=“xs:string” />

</xs:sequence>
<xs:attribute name=“ID” type=“xs:ID” />
<xs:attribute name=“Language” type=“xs:language” />
<xs:attribute name=“ThumbSettings” type=“xs:string” />
<xs:attribute name=“Encoding” type=“xs:string” />

</xs:extension>

</xs:complexContent>

</xs:complexType>
<xs:complexType name=“Target” abstract=“true”>

<xs:attribute name=“Name” type=“xs:string” />

</xs:complexType>
<xs:complexType name=“ItemParam”>

<xs:simpleContent>

<xs:extension base=“xs:string”>

<xs:attribute name=“Category” type=“xs:string” />

</xs:extension>

</xs:simpleContent>

</xs:complexType>
<xs:complexType name=“Menu”>

<xs:complexContent mixed=“false”>

<xs:extension base=“tns:Content”>

<xs:sequence>

<xs:element minOccurs=“0” maxOccurs=“unbounded” name=“Element” nillable=“true”

type=“tns:Element” />

<xs:element minOccurs=“0” maxOccurs=“1” name=“Buttons” type=“tns:Buttons” />

</xs:sequence>
<xs:attribute name=“StyleID” type=“xs:string” />
<xs:attribute name=“MenuStyleID” type=“xs:string” />

</xs:extension>

</xs:complexContent>

</xs:complexType>
<xs:complexType name=“Element”>

<xs:sequence>

<xs:element minOccurs=“0” maxOccurs=“1” name=“Target” type=“tns:TargetContents” />

</xs:sequence>
<xs:attribute name=“ID” type=“xs:Name” />
<xs:attribute name=“Target” type=“xs:string” />
<xs:attribute name=“Chapter” type=“xs:int” />
<xs:anyAttribute processContents=“skip” />

</xs:complexType>
<xs:complexType name=“TargetContents”>

<xs:sequence>

<xs:choice minOccurs=“1” maxOccurs=“1”>

<xs:element minOccurs=“0” maxOccurs=“1” name=“Menu” type=“tns:Menu” />
<xs:element minOccurs=“0” maxOccurs=“1” name=“SlideShow” type=“tns:SlideShow” />
<xs:element minOccurs=“0” maxOccurs=“1” name=“Media” type=“tns:Media” />

</xs:choice>

</xs:sequence>

</xs:complexType>
<xs:complexType name=“Media”>

<xs:complexContent mixed=“false”>

<xs:extensionbase=“tns:Content”>

<xs:sequence>

<xs:element minOccurs=“0” maxOccurs=“unbounded” name=“ChapterPoint” nillable=“true”

type=“tns:ChapterPoint” />

<xs:element minOccurs=“0” maxOccurs=“unbounded” name=“Subtitle” nillable=“true”

type=“tns:Subtitle” />

</xs:sequence>
<xs:attribute name=“Source” type=“xs:anyURI” />
<xs:attribute name=“Destination” type=“xs:string” />
<xs:attribute name=“EndAction” type=“xs:IDREF” />

</xs:extension>

</xs:complexContent>

</xs:complexType>
<xs:complexType name=“ChapterPoint”>

<xs:attribute name=“Time” type=“xs:time” use=“required” />

</xs:complexType>
<xs:complexType name=“Subtitle”>

<xs:sequence>

<xs:element minOccurs=“0” maxOccurs=“1” name=“Color” type=“xs:string” />
<xs:element minOccurs=“0” maxOccurs=“1” name=“Font” type=“xs:string” />
<xs:element minOccurs=“0” maxOccurs=“1” name=“Alignment” type=“xs:string” />
<xs:choice minOccurs=“0” maxOccurs=“unbounded”>

<xs:element minOccurs=“1” maxOccurs=“1” name=“TextDrawItem” nillable=“true”

type=“tns:TextDrawItem” />

<xs:element minOccurs=“1” maxOccurs=“1” name=“StillImageDrawItem” nillable=“true”

type=“tns:StillImageDrawItem” />

</xs:choice>

</xs:sequence>
<xs:attribute name=“PlayStart” type=“xs:time” use=“required” />

</xs:complexType>
<xs:complexType name=“TextDrawItem”>

<xs:complexContent mixed=“false”>

<xs:extensionbase=“tns:DrawItem”>

<xs:sequence>

<xs:element minOccurs=“0” maxOccurs=“1” name=“Text” type=“xs:string” />
<xs:element minOccurs=“0” maxOccurs=“1” name=“Color” type=“xs:string” />
<xs:element minOccurs=“0” maxOccurs=“1” name=“Font” type=“xs:string” />
<xs:element minOccurs=“0” maxOccurs=“1” name=“Alignment” type=“xs:string” />

</xs:sequence>

</xs:extension>

</xs:complexContent>

</xs:complexType>
<xs:complexType name=“DrawItem” abstract=“true”>

<xs:sequence>

<xs:element minOccurs=“0” maxOccurs=“1” name=“DestinationRect” type=“tns:Rectangle32Bit” />

</xs:sequence>

</xs:complexType>
<xs:complexTypename=“Rectangle32Bit”>

<xs:attribute name=“Left” type=“xs:int” use=“required” />
<xs:attribute name=“Top” type=“xs:int” use=“required” />
<xs:attribute name=“Width” type=“xs:int” use=“required” />
<xs:attribute name=“Height” type=“xs:int” use=“required” />

</xs:complexType>
<xs:complexType name=“StillImageDrawItem”>

<xs:complexContent mixed=“false”>

<xs:extensionbase=“tns:DrawItem”>

<xs:sequence>

<xs:element minOccurs=“1” maxOccurs=“1” name=“File” nillable=“true” type=“xs:anyURI” />
<xs:element minOccurs=“0” maxOccurs=“1” name=“SourceRect” type=“tns:Rectangle32Bit” />

</xs:sequence>

</xs:extension>

</xs:complexContent>

</xs:complexType>
<xs:complexType name=“Buttons”>

<xs:sequence>

<xs:element minOccurs=“0” maxOccurs=“unbounded” name=“Button” type=“tns:Element” />

</xs:sequence>
<xs:attribute name=“UseID” type=“xs:string” />

</xs:complexType>
<xs:simpleType name=“EnumDiscType”>

<xs:restriction base=“xs:string”>

<xs:enumeration value=“Dvd” />
<xs:enumeration value=“Vcd” />
<xs:enumeration value=“SVcd” />
<xs:enumeration value=“HighMAT_CD” />

</xs:restriction>

</xs:simpleType>
<xs:simpleType name=“EnumVideoSetting”>

<xs:restriction base=“xs:string”>

<xs:enumeration value=“Ntsc” />
<xs:enumeration value=“Pal” />

</xs:restriction>

</xs:simpleType>
<xs:simpleType name=“EnumAspectRatio”>

<xs:restriction base=“xs:string”>

<xs:enumeration value=“4:3” />
<xs:enumeration value=“16:9” />

</xs:restriction>

</xs:simpleType>

</xs:schema>

### Appendix 2

Appendix 2 is an exemplary test model for a single element “Project” generated by a generator or method of the invention.

Exemplary Test Model 112

############################################################
# Model for Project Element
############################################################
ROMSectionRoot:0,1
SubpicturePalette:0,1
_ChoiceParameter1:SKIP,SlideShow,Media,Menu
_ChoiceParameter2:SKIP,SlideShow,Media,Menu
_ChoiceParameter3:SKIP,SlideShow,Media,Menu
_ChoiceParameter4:SKIP,SlideShow,Media,Menu
_ChoiceParameter5:SKIP,SlideShow,Media,Menu
Project.Name:TestDVD,MyTestDVD,WhatIsThis,JWSalmon
Project.FirstPlay:MainMenu
Project.JacketPicture:SKIP
Project.SchemaVersion:1.0
Project.Language:eng
Project.Encoding:786K,128K,56K,2.1M,1.8M
Project.DiscBurner:D,E,F,G
Project.DiscVolumeOnHardDrive:C:\TestDVD
Project.TempFolder:C:\Temp
Project.DiscType:DVD,VCD
Project.VideoSetting:NTSC,PAL
Project.AspectRatio:4:3,16:9
Project.NumberOfCopies:1,2,10,100
Project.AutoMenus:true,false
############################################################
# Special groups of parameters can be defined in sub-models
############################################################
############################################################
# Special conditions are captured in constraints
############################################################
if [_ChoiceParameter1] = “SKIP” then [_ChoiceParameter2] = “SKIP”;
if [_ChoiceParameter2] = “SKIP” then [_ChoiceParameter3] = “SKIP”;
if [_ChoiceParameter3] = “SKIP” then [_ChoiceParameter4] = “SKIP”;
if [_ChoiceParameter4] = “SKIP” then [_ChoiceParameter5] = “SKIP”;

### Appendix 3

Appendix 3 is an exemplary values file generated by a generator or method of the invention (which file may be modified by a user) to specify values for specific elements and attributes during model generation.

Exemplary Value File 116

### This file is generated by PictModelGen with all elements and attributes of primitive types

### within the given schema. Users must fill in the specific values that PictModelGen can use

### during actual model generation. Elements and attributes without values will have a default

### value of “SKIP”. Set of values must remain in the same line and separated by “,”.

### Example: Element.Attribute=“foo”,“bar”

### Note: Values must not have a terminating character.

Media.Name(string)=“Introduction to Windows”, “Ascent Wallpaper”, “Azul Wallpaper”, “Stonehenge

Wallpaper”, “John West Salmon”, “Ping-pong Matrix”

Media.ID(ID)=v.intro, i.ascent, i.azul, i.stonehenge, v.salmon, v.matrix

Media.Language(language)=eng, fra, deu, cht, chs, jpn, kor, spa, ita

Media.ThumbSettings(string)=

Media.Encoding(string)=786K, 128K, 56K, 2.1M, 1.8M

Media.Source(anyURI)=intro.wmv, Ascent.jpg, Azul.jpg, Stonehenge.jpg, salmon,mpg, Matrix.avi

Media.Destination(string)=HighMAT

Media.EndAction(IDREF)=MainMenu

Subtitle.PlayStart(time)=00:00:00, 00:00:10, 00:00:25

DestinationRect.Left(int)=

DestinationRect.Top(int)=

DestinationRect.Width(int)=

DestinationRect.Height(int)=

Menu.Name(string)=“Main Menu”, “Chapter Menu”, “Notes Menu”

Menu.ID(ID)=MainMenu, ChapterMenu, NotesMenu

Menu.Language(language)=eng, fra, deu, spa

Menu.ThumbSettings(string)=

Menu.Encoding(string)=unicode, utf-8

Menu.StyleID(string)=White, Blue, Avalon1

Menu.MenuStyleID(string)=MainMenu, ChapterMenu, NotesMenu

ItemParam.Category(string)=video, image, audio

Project.Name(string)=TestDVD, MyTestDVD, WhatIsThis, JWSalmon

Project.FirstPlay(string)=MainMenu

Project.JacketPicture(anyURI)=

Project.SchemaVersion(string)=1.0

Project.Language(language)=eng

Project.Encoding(string)=786K, 128K, 56K, 2.1M, 1.8M

Project.DiscBurner(string)=D, E, F, G

Project.DiscVolumeOnHardDrive(string)=C:\TestDVD

Project.TempFolder(string)=C:\Temp

Project.DiscType(EnumDiscType)=DVD, VCD

Project.VideoSetting(EnumVideoSetting)=NTSC, PAL

Project.AspectRatio(EnumAspectRatio)=4:3, 16:9

Project.NumberOfCopies(int)=1, 2, 10, 100

Project.AutoMenus(boolean)=true, false

Font=Verdana, Aerial, Courier

Element.ID(Name)=TitleText, NoteText, Preview, Parent

Element.Target(string)=MainMenu, ChapterMenu, NotesMenu, Video1

Element.Chapter(int)=1, 2, 3, 4, 5

SubpicturePalette=

File=

Text=

Buttons.UseID(string)=MyButton, MyChapterButton

ChapterPoint.Time(time)=00:00:00, 00:00:05, 00:00:10

SourceRect.Left(int)=

SourceRect.Top(int)=

SourceRect.Width(int)=

SourceRect.Height(int)=

Folder.Name(string)=C:\Temp, C:\TempDVD, C:\TempDVD\ROMSection

Alignment=left, center, right, adjusted

Color=red, blue, green, yellow, cyan, magenta, black, white

SlideShow.Name(string)=MySlideShow

SlideShow.ID(ID)=s.myshow

SlideShow.Language(language)=eng, fra, deu, cht, chs, jpn, kor, spa, ita

SlideShow.ThumbSettings(string)=

SlideShow.Encoding(string)=786K, 128K, 56K, 2.1M, 1.8M

SlideShow.PlayDuration(time)=00:00:10, 00:01:00, 00:33:33, 99:99:99

SlideShow.TransitionDuration(time)=00:00:03, 00:00:10, 00:01:00

SlideShow.BackgroundAudio(anyURI)=title.wma, “Space SysStart.wav”, barbie.mp3

SlideShow.EndAction(IDREF)=MainMenu

Button.ID(Name)=btn1, btn2, btn3, btn4, btn5, btn6, btn7, btn8, btn9

Button.Target(string)=v.intro, i.ascent, i.azul, i.stonehenge, v.salmon, v.matrix, MainMenu, ChapterMenu, NotesMenu

Button.Chapter(int)=1, 2, 3, 4, 5

ROMSectionRoot.Name(string)=“ROM Section”, “High Definition Data”

### Appendix 4

Appendix 4 is an exemplary test matrix generated by a generator or method of the invention.

Exemplary Test Matrix 114

This is a partial matrix for the element “Project”, based on the test model shown in Appendix 2. It shows 3 test cases in the matrix, out of a total of 38. The 38 test cases were generated using a permutation engine with a combinatorial order of 2.

Testcase[0]

| | |
|---|---|
| ROMSectionRoot occurance = | 0 |
| SubpicturePalette occurance = | 0 |
| ChoiceParameter1 = | Media |
| ChoiceParameter2 = | SlideShow |
| ChoiceParameter3 = | Menu |
| ChoiceParameter4 = | Media |
| ChoiceParameter5 = | Menu |
| Name = | JWSalmon |
| FirstPlay = | MainMenu |
| JacketPicture = | SKIP |
| SchemaVersion = | 1.0 |
| Language = | eng |
| Encoding = | 2.1 M |
| DiscBurner = | E |
| DiscVolumeOnHardDrive = | C:\TestDVD |
| TempFolder = | C:\Temp |
| DiscType = | VCD |
| VideoSetting = | PAL |
| AspectRatio = | 4:3 |
| NumberOfCopies = | 100 |
| AutoMenus = | true |

Testcase[1]

| | |
|---|---|
| ROMSectionRoot occurance = | 0 |
| SubpicturePalette occurance = | 1 |
| ChoiceParameter1 = | SKIP |
| ChoiceParameter2 = | SKIP |
| ChoiceParameter3 = | SKIP |
| ChoiceParameter4 = | SKIP |
| ChoiceParameter5 = | SKIP |
| Name = | WhatIsThis |
| FirstPlay = | MainMenu |
| JacketPicture = | SKIP |
| SchemaVersion = | 1.0 |
| Language = | deu |
| Encoding = | 1.8 M |
| DiscBurner = | G |
| DiscVolumeOnHardDrive = | C:\TestDVD |
| TempFolder = | C:\Temp |
| DiscType = | DVD |
| VideoSetting = | NTSC |
| AspectRatio = | 16:9 |
| NumberOfCopies = | 2 |
| AutoMenus = | true |

Testcase[2]

| | |
|---|---|
| ROMSectionRoot occurance = | 0 |
| SubpicturePalette occurance = | 0 |
| ChoiceParameter1 = | Menu |
| ChoiceParameter2 = | Media |
| ChoiceParameter3 = | Media |
| ChoiceParameter4 = | Menu |
| ChoiceParameter5 = | SlideShow |
| Name = | JWSalmon |
| FirstPlay = | MainMenu |
| JacketPicture = | SKIP |
| SchemaVersion = | 1.0 |
| Language = | eng |
| Encoding = | 786K |
| DiscBurner = | F |
| DiscVolumeOnHardDrive = | C:\TestDVD |
| TempFolder = | C:\Temp |
| DiscType = | DVD |
| VideoSetting = | PAL |
| AspectRatio = | 16:9 |
| NumberOfCopies = | 1 |
| AutoMenus = | false |

### Appendix 5

Appendix 5 is an exemplary constraints file generated by a generator or method of the invention (which file may be modified by a user) to specify contraining conditions for the permutations engine to follow when it executes combinatorial permutations.

Exemplary Constraints File 118

### This file should contain all the constraints to be added during test model generation. Constraints

### for each element in the schema should reside under each of its respective section as indicated by

### the section headers. Syntax for contraint should follow that of PICT. For details please refer to

### PICT User's Guide at—http://winweb/pairwise/documents/pict/pict_users_guide.htm

### Example: [Element.Attribute1]>≦[Element.Attribute2];

### Example: IF [Element1.Attribute1] in {value 1, value2} THEN Element2.Attribute2 in {value3, value4};

### Note: Each constraints must be terminated by a “;”.

(Media)

(Subtitle)

(DestinationRect)

(TextDrawItem)

(Menu)

[Menu.ID]=[Menu.MenuStyleID];

(ItemParam)

(Font)

(Element)

(SubpicturePalette)

(File)

(Text)

(OpticalMediaDiscProject)

if [OpticalMediaDiscProject.DiscType]=“DVD” then [OpticalMediaDiscProject.AspectRatio]=“16:9”;

(Buttons)

(ChapterPoint)

(SourceRect)

(Folder)

(StillImageDrawItem)

(Alignment)

(Color)

(SlideShow)

(Button)

(Target)

(ROMSectionRoot)

### Appendix 6

Appendix 6 is an exemplary annotation file generated by a generator or method of the invention (which file may be modified by a user) to specify generation patterns during instance generation.

Exemplary Annotation File 120

### This file should contain all the annotations to be applied during test model generation.

### Annotations for each element in the schema should reside under each of its respective section

### as indicated by the section headers in parantheses. New sections can be added in any order.

### Syntax for annotations should follow that of regular expressions.

### Note: Each annotation must be terminated by a “;”.

(File)

File=[a-z]*[A-Z]*;

(Text)

Text=\d{2}-\d{5};

What is claimed is:

1. A CRM having stored thereon instructions for testing an XML-based application interface as defined by an XSD schema and for determining whether the XML-based application interface exposed by an application under test conforms to functional and feature specifications of a design corresponding to the application, said instructions comprising:
model generator instructions for parsing the XSD schema to selectively identify metadata defined in the XSD schema for generating test models corresponding to the identified metadata; and
test case generator instructions for generating test matrices corresponding to the test models.

2. The instructions of claim 1 wherein the model generator instructions comprise a parsing stage for parsing the XSD schema and a test model generating stage for generating a test model for each identified metadata.

3. The instructions of claim 2 wherein the test case generator instructions comprises a test matrices stage for generating the test matrices from the test models and a test document generating stage for generating XML documents from the test matrices, said XML documents being applied to the application interface to test whether the interface exposed by the application under test conforms to functional and feature specifications of the design corresponding to the application.

4. The instructions of claim 3 wherein the test matrices stage employs a permutation engine for generating combinatorial test matrices for the test models.

5. The instructions of claim 4 further comprising a value file generated by the model generator describing content or value of the metadata used to generate the test models.

6. The instructions of claim 5 further comprising a constraints file generated by the model generator describing constraining conditions used by the permutation engine with respect to the generation of the combinatorial test matrices.

7. The instructions of claim 6 further comprising an annotation file generated by the model generator describing generation patterns for the XML documents.

8. The instructions of claim 7 wherein at least one of the following is capable of being modified by a user: the value file, the constraints file and the annotation file.

9. A method of testing an XML-based application interface as defined by an XSD schema, with respect to an application exposing such an interface, said method comprising:
parsing the XSD schema to selectively identify metadata defined in the XSD schema;
generating test models corresponding to the identified metadata;
generating test matrices corresponding to the test models; and
generating XML documents using the test matrices.

10. The method of claim 9 wherein the model generator instructions comprise parsing instructions for parsing the XSD schema and test model generating instructions for generating a test model for each identified metadata.

11. The method of claim 10 wherein the test case generator instructions comprises test matrices instructions for generating the test matrices from the test models and test document generating instructions for generating XML documents from the test matrices, said XML documents being applied to the application interface to test whether the interface exposed by the application under test conforms to functional and feature specifications of the design corresponding to the application.

12. The method of claim 11 wherein the test matrices instructions include a permutation instruction for generating combinatorial test matrices for the test models.

13. The method of claim 12 further comprising generating a value file generated describing content or value of the metadata used to generate the test models.

14. The method of claim 13 further comprising generating a constraints file describing constraining conditions used by the permutation instructions for generating the combinatorial test matrices.

15. The method of claim 14 further comprising generating an annotation file describing generation patterns for the XML documents.

16. The method of claim 15 wherein at least one of the following is capable of being modified by a user: the value file, the constraints file and the annotation file.

17. A CRM having stored thereon an XML test generator for an XML application interface comprising:
a test model generator, which parses an XSD schema defining the XML interface and generates a separate test model for each element within it;
a customizable permutation engine which performs combinatorial permutations of variables within the generated test models; and
an XML instance generator, which uses the permutation engine to build combinatorial test matrices as a function of the generated test models.

18. The generator of claim 17 wherein the test model generator comprises a parsing stage for parsing the XSD schema and a test model generating stage for generating a test model for each identified metadata.

19. The generator of claim 18 wherein the XML instance generator comprises a test matrices stage for generating the test matrices from the test models and a test document generating stage for generating XML documents from the test matrices, said XML documents being applied to the application interface to test whether the interface exposed by the application under test conforms to functional and feature specifications of a design corresponding to the application.

20. The generator of claim 19 wherein the test matrices stage employs a permutation engine for generating combinatorial test matrices for the test models.

21. The generator of claim 20 further comprising a value file generated by the model generator describing content or value of the metadata used to generate the test models.

22. The generator of claim 21 further comprising a constraints file generated by the model generator describing constraining conditions used by the permutation engine with respect to the generating of the combinatorial test matrices.

23. The generator of claim 22 further comprising an annotation file generated by the model generator describing generation patterns for the XML documents.

24. The generator of claim 23 wherein at least one of the following is capable of being modified by a user: the value file, the constraints file and the annotation file.

25. A system comprising:
a memory area storing model generator instructions for parsing an XSD schema to selectively identify metadata defined in the XSD schema for generating test models corresponding to the identified metadata; and storing test case generator instructions for generating test matrices corresponding to the test models; and
a processor for executing the stored model generator instructions and the stored test generator instructions.

26. The system of claim 25 wherein the model generator instructions comprise a parsing stage for parsing the XSD schema and a test model generating stage for generating a test model for each identified metadata.

27. The system of claim 26 wherein the test case generator instructions comprises a test matrices stage for generating the test matrices from the test models and a test document generating stage for generating XML documents from the test matrices, said XML documents being applied to the application interface to test whether the interface exposed by the application under test conforms to functional and feature specifications of a design corresponding to the application.

28. The system of claim 27 wherein the test matrices stage employs a permutation engine for generating combinatorial test matrices for the test models.

29. The system of claim 28 further comprising a value file generated by the model generator describing content or value of the metadata used to generate the test models.

30. The system of claim 29 further comprising a constraints file generated by the model generator describing constraining conditions used by the permutation engine with respect to the generating of the combinatorial test matrices.

31. The system of claim 30 further comprising an annotation file generated by the model generator describing generation patterns for the XML documents.

32. The system of claim 31 wherein at least one of the following is capable of being modified by a user: the value file, the constraints file and the annotation file.

33. A system comprising:
a processor for executing an application exposing an XML-based application interface defined by an XSD schema;
means for generating test models for metadata defined by the XSD schema;
means for generating test matrices from the test models, said test matrices including permutations of the metadata; and
means for generating XML test documents from the test matrices, said test documents being applied to the XML application interface to determine whether the XML application interface exposed by the application under test conforms to functional and feature specifications of a design corresponding to the application.

34. The system of claim 33 wherein the means for generating test modes comprises a parsing stage for parsing the XSD schema and a test model generating stage for generating a test model for each identified metadata.

35. The system of claim 34 wherein the means for generating test matrices comprises a test matrices stage for generating the test matrices from the test models, said XML documents being applied to the application interface to test whether the interface exposed by the application under test conforms to functional and feature specifications of the design corresponding to the application.

36. The system of claim 35 wherein the test matrices stage employs a permutation engine for generating combinatorial test matrices for the test models.

37. The system of claim 36 further comprising a value file generated by the model generator describing content or value of the metadata used to generate the test models.

38. The system of claim 37 further comprising a constraints file generated by the model generator describing constraining conditions used by the permutation engine with respect to the generating of the combinatorial test matrices.

39. The system of claim 38 further comprising an annotation file generated by the model generator describing generation patterns for the XML documents.

40. The system of claim 39 wherein at least one of the following is capable of being modified by a user: the value file, the constraints file and the annotation file.
